(19) United States
(12) Patent Application Publication
(10) Pub. No.: US 2013/0241174 A1
(43) Pub. Date: Sep. 19, 2013

(54) BICYCLE WITH CHARGEPORT STORAGE

(71) Applicants: Robert F. Meyer, Mountain View, CA (US); Ian M. Hamilton, San Jose, CA (US); Jan Talavasek, Knonau (CH)

(72) Inventors: Robert F. Meyer, Mountain View, CA (US); Ian M. Hamilton, San Jose, CA (US); Jan Talavasek, Knonau (CH)

(73) Assignee: SPECIALIZED BICYCLE COMPONENTS, INC., Morgan Hill, CA (US)

(21) Appl. No.: 13/422,826

(22) Filed: Mar. 16, 2012

(51) Int. Cl. B62K 3/06

(52) U.S. Cl. 280/281.1; 280/288.4

(57) ABSTRACT

A bicycle frame including a head tube, a bottom bracket adapted to support a crankset, and a tubular frame member that defines a compartment. The bicycle frame also includes a battery pack disposed in the compartment and a chargeport coupled to the tubular frame member. The chargeport includes an electrical contact that is accessible from outside the tubular frame member and that is electrically coupled to the battery pack. A chargeport cover is magnetically coupled to the chargeport to enclose the electrical contact, and is further engageable with the tubular frame member when the chargeport cover is removed from the chargeport.

### BACKGROUND

The present invention relates generally to bicycles, and more specifically to bicycles including a chargeport.

Bicycles commonly have a main frame and a front fork pivotally secured to the main frame. The main frame typically includes a top tube, a down tube, a seat tube, and a rear wheel mount for receiving a rear wheel axle. The front fork typically includes a front wheel mount for receiving a front wheel axle. Steering control of the bicycle is provided by a handlebar that is usually secured to the front fork via a handlebar stem. Some bicycles also include a power source, such as a battery, to provide power to components on the bicycle, and in some cases, to provide motive power to the bicycle.

### SUMMARY

The present invention provides a bicycle frame including a head tube, a bottom bracket adapted to support a crankset, and a tubular frame member that defines a compartment. The bicycle frame also includes a battery pack disposed in the compartment and a chargeport coupled to the tubular frame member. The chargeport includes an electrical contact that is accessible from outside the tubular frame member and that is electrically coupled to the battery pack. A chargeport cover is magnetically coupled to the chargeport to enclose the electrical contact, and is further engageable with the tubular frame member when the chargeport cover is removed from the chargeport.

In another construction, the present invention provides a bicycle frame including a head tube, a bottom bracket adapted to support a crankset, and a tubular frame member coupled to the head tube. A battery pack is coupled to the tubular frame member. The bicycle frame also includes a chargeport housing that is coupled to the tubular frame member, and a chargeport that is attached to the chargeport housing. The chargeport has an electrical contact accessible from outside the tubular frame member and electrically connected to the battery pack. A chargeport cover is magnetically coupled to the chargeport to enclose the electrical contact, and the tubular frame member defines a storage location for the chargeport cover near the chargeport for storing the chargeport cover on the tubular frame member upon removal from the chargeport.

In another construction, the present invention provides a method of storing a chargeport cover on a bicycle frame that includes a tubular frame member and a chargeport electrically connected to a battery pack supported by the bicycle frame. The method includes engaging a chargeport cover with the chargeport, and storing the chargeport cover on the tubular frame member upon removal of the chargeport cover from the chargeport.

Other aspects of the invention will become apparent by consideration of the detailed description and accompanying drawings.

### BRIEF DESCRIPTION OF THE DRAWINGS

FIG. 1 is a side view of a bicycle including a frame embodying the present invention.

FIG. 2 is a perspective view of a portion of a down tube of the frame illustrated in FIG. 1, including a chargeport housing and a chargeport cover.

FIG. 3. is an exploded view of the down tube of FIG. 2, illustrating the chargeport housing, the chargeport cover, a chargeport, and a chargeport cover storage feature.

FIG. 4 is a cross-section of the down tube taken along line 4-4 in FIG. 2, illustrating the chargeport cover connected to the chargeport within the chargeport housing.

FIG. 5 is another cross-section of the down tube illustrating the chargeport cover coupled to the chargeport housing over the chargeport cover storage feature.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

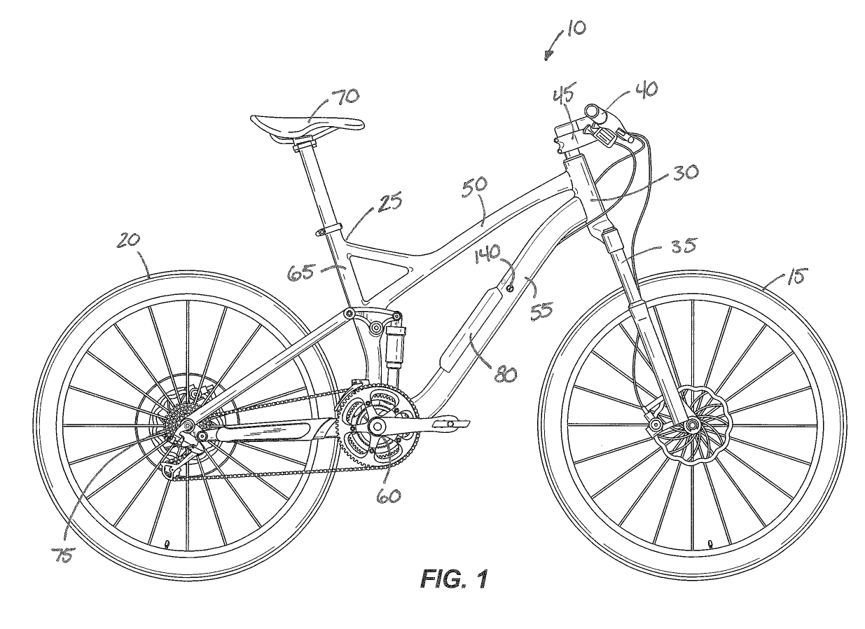

FIG. 1 shows a bicycle 10 that includes a front wheel 15, a rear wheel 20, and a frame 25. The frame 25 has a head tube 30 and a front fork 35 that is rotationally supported by the head tube 30 and that secures the front wheel 15 to the frame 25. A handlebar assembly 40 is coupled to the head tube 30 and is secured to the front fork 35 by a stem assembly 45 such that movement of the handlebar 40 results in movement of the stem assembly 45 and the fork 35.

The frame 25 also has a top tube 50 connected to and extending rearward from the head tube 30, and a down tube 55 connected to the head tube 30 below the top tube 50 and extending generally downward toward a drive train 60. A seat tube 65 is connected to the top tube 50 and the down tube 55, and a seat 70 is supported by the seat tube 65.

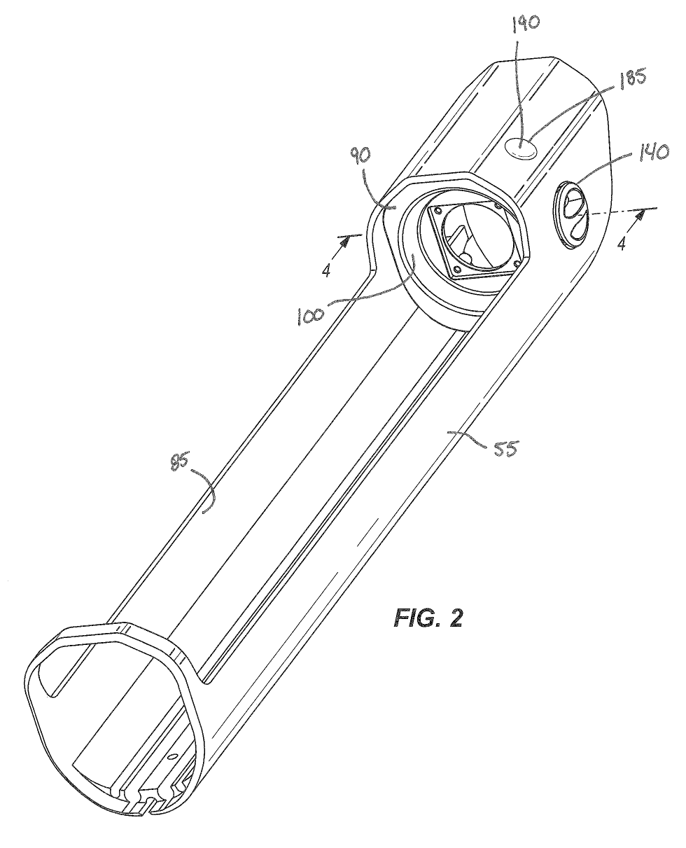

The frame 25 also has a top tube 50 connected to and extending rearward from the head tube 30, and a down tube 55 connected to the head tube 30 below the top tube 50 and extending generally downward toward and connected to a bottom bracket 60 of the frame 25. With reference to FIG. 2, the illustrated down tube 55 has an oblong or rounded trapezoidal cross-sectional profile. A seat tube 65 extends upward from the bottom bracket 60 and is connected to the top tube 50, and a seat 70 is supported by the seat tube 65. The illustrated frame 25 is formed from non-magnetic material (e.g., aluminum, composite, etc.).

The bicycle 10 also can include a motor (not shown) that is drivingly coupled to a rear sprocket assembly 75 to selectively provide motive force for the bicycle 10 and/or to act as a generator for an electrical circuit (not shown) of the bicycle 10. The motor is electrically connected to a power source or battery pack 80, which may also serve as a controller for the motor and/or other electrical accessories on the bicycle 10. In some constructions, the motor may be excluded from the bicycle 10.

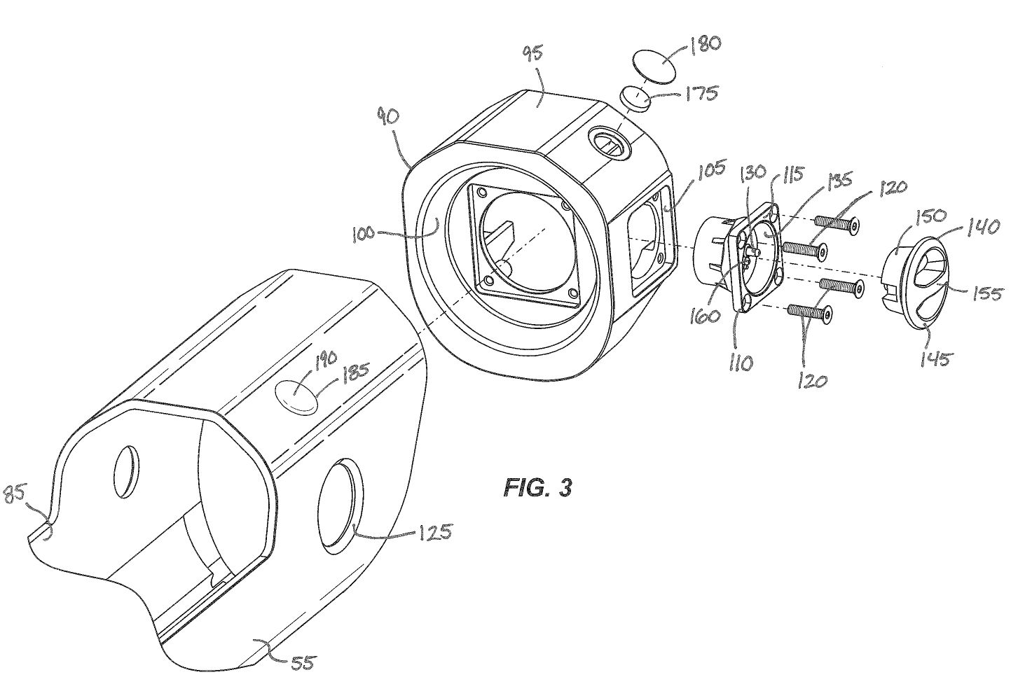

With reference to FIGS. 1 and 2, the battery pack 80 is disposed in a compartment 85 of the down tube 55, although the battery pack 80 can be disposed in another tubular frame member (e.g., the top tube 50, the seat tube 65, etc.). FIGS. 2 and 3 show a chargeport housing or receiver 90 that is disposed in the down tube 55 adjacent and in communication with the compartment 85. More specifically, the chargeport housing 90 is enclosed within the down tube 55 and has an exterior wall 95 that substantially conforms to the inner hollow profile of the down tube 55. The chargeport housing 90 also includes an axially aligned first recessed area or tapered socket 100 that is coupled with the battery pack 80, and a second recessed area or socket 105 that is accessible from the exterior wall 95 and orthogonal to the first recessed area 100.

A chargeport 110 is attached to the chargeport housing 90 within the second recessed area 105 so that an outer surface 115 of the chargeport 110 is substantially flush with the exterior wall 95. Fasteners 120 secure the chargeport 110 to the chargeport housing 90. As illustrated, when the chargeport housing 90 is placed in the down tube 55, the chargeport 110 is accessible from outside the down tube 55 via a hole 125. The chargeport 110 includes an electrical contact 130 that is electrically connected on the back end to the battery pack 80 via wires (not shown) extending between the battery pack 80 and the chargeport housing 90. As illustrated, the chargeport 110 has a cylindrical recess 135 via which the electrical contact 130 is exposed on the front end. The electrical contact 130 illustrated in FIGS. 3 and 5 takes the form of a pin-type electrical connector, although other types of electrical connectors are possible. Also, the chargeport can be directly coupled to the down tube 55 (or another tubular frame member) in the absence of the chargeport housing 90.

With reference to FIGS. 2-4, the chargeport 110 is covered or enclosed by a chargeport cover 140 to protect the electrical contact 130 from debris, fluids, and other material to which the down tube 55 may be exposed. Without the cover 140, the chargeport 110 is exposed to the environment. The chargeport cover 140 is defined by a flange 145 and cylindrical body 150 that conforms to and fits within the cylindrical recess 135. The flange 145 has a bridge or gripping portion 155 so that the chargeport cover 140 can be installed on and removed from the chargeport 110.

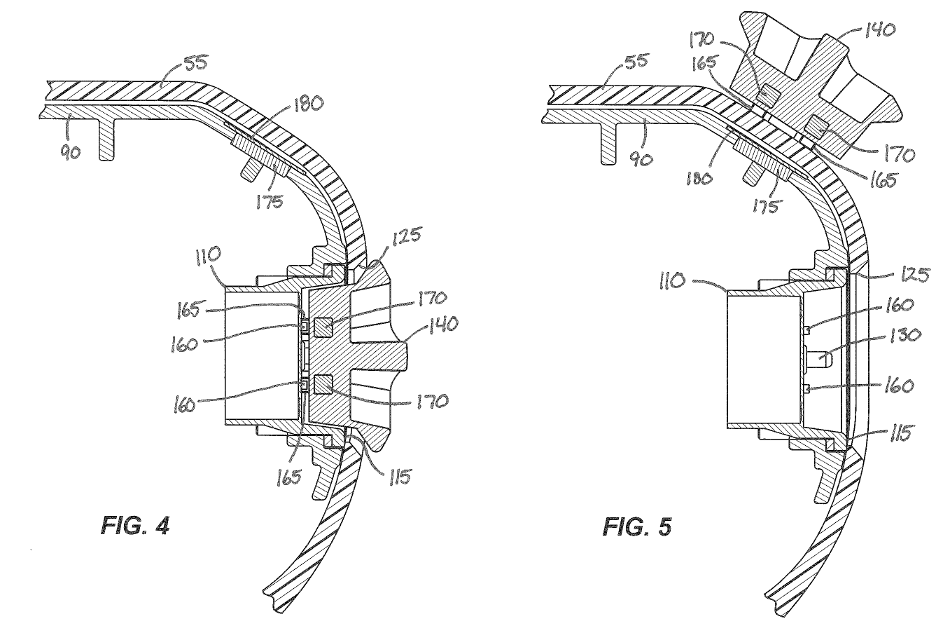

The cylinder body 150 has a blind hole (not shown) that receives the electrical contact 130. Also, the chargeport 110 includes pins or protrusions 160 (two protrusions 160 illustrated in FIG. 4) that surround the electrical contact 130 and that are received in sleeves 165 on the distal end of the cylindrical body 150. The protrusions 160 are magnetized and cooperate with first magnets 170 (two shown) disposed in the chargeport cover 140 to align and attach the chargeport cover 140 to the chargeport 110. As illustrated, the magnets 170 are located near the distal end of the cylindrical body 150 and have a polarity that is opposite the polarity of the magnetized protrusions 160.

Referring to FIG. 3, a second magnet 175 is coupled to the exterior wall 95 of the chargeport housing 90 and cooperates with the first magnets 170 to store the chargeport cover 140 upon removal of the chargeport cover 140 from the chargeport 110. The second magnet 175 is recessed in the exterior wall 95 and is enclosed by the down tube 55 when the chargeport housing 90 is installed in the down tube 55. As illustrated, an optional non-magnetized plate 180 is positioned over the second magnet 175 to hold the magnet 175 in place on the chargeport housing 90. In other constructions, the second magnet 175 can be attached to the chargeport housing 90 without the plate 180, directly attached to the inside surface of the down tube 55, to the outside surface of the down tube 55, or attached to another component in the down tube 55 (or another frame member) for securing the chargeport cover 140 to the corresponding frame member.

The orientation and location of the second magnet 175 relative to the down tube defines a storage location 185 on the down tube 55 for the chargeport cover 140 when the chargeport cover 140 is removed from the chargeport 110 (e.g., when the battery pack 80 is being charged). With reference to FIG. 3, the down tube 55 can have indicia 190 (e.g., a decal, a recessed area, a scribed area, etc.) that aligns with or overlays the second magnet 175 to identify the storage location 185. The illustrated storage location 185 (and corresponding location of the second magnet 175) is relatively close to or near the chargeport 110 (e.g., less than two inches from the chargeport 110) so the storage location 185 is easily identifiable by a user of the bicycle 10. Generally, the storage location 185 can be anywhere on the down tube 55, although locating the storage location 185 within four inches of the chargeport 110 is preferable.

As illustrated in FIG. 4, the chargeport cover 140 is coupled to the chargeport 110 during operation of the bicycle 10 to protect the electrical contact 130 from the environment. As illustrated in FIG. 5, when access to the electrical contact 130 is necessary (e.g., when the battery pack 80 is being charged), the chargeport cover 140 is removed from the chargeport 110 and placed on the storage location 185. The first and second magnets 170, 175 magnetically engage each other through the down tube 55 so that the chargeport cover 140 is not lost or damaged after the chargeport cover 140 is removed from the chargeport 110. The close proximity of the storage location 185 to the chargeport 110 and the optional indicia 190 on the down tube 55 provides the user with an easily identifiable location on the bicycle 10 for storing the chargeport cover 140 when the cover 140 is not being used.

Various features and advantages of the invention are set forth in the following claims.

1. A bicycle frame comprising:
a head tube;
a bottom bracket adapted to support a crankset;
a tubular frame member defining a compartment;
a battery pack disposed in the compartment;
a chargeport coupled to the tubular frame member and including an electrical contact accessible from outside the tubular frame member and electrically coupled to the battery pack; and
a chargeport cover magnetically coupled to the chargeport to enclose the electrical contact, the chargeport cover further engageable with the tubular frame member when the chargeport cover is removed from the chargeport.

2. The bicycle frame of claim 1, wherein the tubular frame member is a down tube coupled to the head tube and the bottom bracket.

3. The bicycle frame of claim 1, further comprising a magnet coupled to the tubular frame member for storing the chargeport cover on the tubular frame member upon removal from the chargeport.

4. The bicycle frame of claim 3, wherein the magnet is disposed in the tubular frame member, and wherein the tubular frame member has indicia identifying a storage location for the chargeport cover on the tubular frame member when the battery pack is being charged.

5. The bicycle frame of claim 4, wherein the storage location is near the chargeport.

6. The bicycle frame of claim 3, further comprising a chargeport housing disposed in the tubular frame member and supporting the chargeport so that the chargeport can be electrically connected to the battery pack, wherein the magnet is coupled to the chargeport housing.

7. The bicycle frame of claim 6, wherein the magnet is coupled to an exterior wall of the chargeport housing.

8. The bicycle frame of claim 7, wherein the magnet is recessed in the exterior wall, and wherein a non-magnetized plate encloses the magnet.

9. A bicycle frame comprising:
a head tube;
a bottom bracket adapted to support a crankset;
a tubular frame member coupled to the head tube;
a battery pack coupled to the tubular frame member;
a chargeport housing coupled to the tubular frame member;
a chargeport attached to the chargeport housing and including an electrical contact accessible from outside the tubular frame member, the electrical contact electrically connected to the battery pack; and
a chargeport cover magnetically coupled to the chargeport to enclose the electrical contact,
wherein the tubular frame member defines a storage location for the chargeport cover near the chargeport for storing the chargeport cover on the tubular frame member upon removal from the chargeport.

10. The bicycle frame of claim 9, wherein the tubular frame member has indicia identifying the storage location.

11. The bicycle frame of claim 9, wherein the tubular frame member is a down tube coupled to the head tube and the bottom bracket.

12. The bicycle frame of claim 9, further comprising a magnet coupled to the tubular frame member, wherein the magnet cooperates with the tubular frame member to define the storage location.

13. The bicycle frame of claim 12, wherein the magnet is disposed in the tubular frame member and is coupled to an exterior wall of the chargeport housing.

14. The bicycle frame of claim 13, wherein the magnet is recessed in the exterior wall.

15. The bicycle frame of claim 13, wherein the tubular frame member is formed from non-magnetic material.

16. The bicycle frame of claim 15, wherein the chargeport cover is magnetically engaged with the magnet through the tubular frame member when the battery pack is being charged.

17. A method of storing a chargeport cover on a bicycle frame including a tubular frame member and a chargeport electrically connected to a battery pack supported by the bicycle frame, the method comprising:
engaging a chargeport cover with the chargeport; and
storing the chargeport cover on the tubular frame member upon removal of the chargeport cover from the chargeport.

18. The method of claim 17, further comprising magnetically engaging the chargeport cover to the tubular frame member.

19. The method of claim 18, wherein the magnetically engaging step includes
coupling a magnet to the tubular frame member; and
magnetically engaging the chargeport cover to the magnet through the tubular frame member.

20. The method of claim 17, further comprising
magnetically engaging the chargeport cover to the chargeport; and
magnetically engaging the chargeport cover to the tubular frame member when the battery pack is being charged.
